(19) United States
(12) Patent Application Publication
(10) Pub. No.: US 2024/0383399 A1
(43) Pub. Date: Nov. 21, 2024

(54) LIGHTING SYSTEM FOR ONE OR MORE TRIM ELEMENTS AND LIGHTING SURFACE MODULE

(71) Applicants: Faurecia Innenraum Systeme GmbH, Hagenbach (DE); HELLA GmbH & Co. KGaA, Lippstadt (DE)

(72) Inventors: Maxime Musy, Karlsruhe (DE); Heiko Schöne, Zell im Wiesental (DE)

(73) Assignees: Faurecia Innenraum Systeme GmbH, Hagenbach (DE); HELLA GmbH & Co. KGaA, Lippstadt (DE)

(21) Appl. No.: 18/643,277

(22) Filed: Apr. 23, 2024

(30) Foreign Application Priority Data
Apr. 25, 2023 (DE) 10 2023 203 829.3

(51) Int. Cl. B60Q 3/54; B60Q 3/217; B60Q 3/64; F21V 7/28; F21W 106/00; F21Y 105/16; F21Y 105/18; F21Y 115/10

(52) U.S. Cl. CPC B60Q 3/54; B60Q 3/217; B60Q 3/64; F21V 7/28; F21W 2106/00; F21Y 2105/16; F21Y 2105/18; F21Y 2115/10

(57) ABSTRACT

The invention relates to a lighting system for one or more trim elements (12) for the passenger compartment (5) of a means of passenger transport, in particular a motor vehicle, having a plurality of separate lighting surface modules (1a, 1b, 1c, 1d, 1e, 1f, 1g, 2, 3, 4) which are arranged next to one another and each have at least one light injector (2, 3), and a support (7) to or in which the lighting surface modules are fastened or can be fastened. The invention further relates to suitable lighting surface modules and their shapes and construction, and to a trim element which is equipped with a lighting system having such lighting surface modules.

The invention is in the field of lighting technology and automobile technology and is particularly advantageously applicable to the construction of trim elements in the interior of vehicles.

Trim elements for the interior of vehicles, for example motor vehicles or public transportation vehicles, and also of aircraft and ships, are provided to make passenger compartments safe and pleasant. In many cases, it is expedient to make such trim elements so that they can also be illuminated. For this purpose, lighting systems have been developed in the past which allow trim elements to be illuminated from the rear side as well.

Problems that are to be solved in this design are, on the one hand, to realize the brightness of trim elements uniformly or according to a desired profile, to achieve the coupling in of light as simply, reliably, and cost-effectively as possible, and to keep the outlay for construction and production as low as possible.

German publication DE 10 2019 201 346 A1, for example, discloses a trim element that has a flat, plate-shaped light guide on its side facing away from the passenger compartment, into which guide light is introduced from the rear via a light guide in the region of a light guide dome. A plurality of such light guide domes can also be provided on the trim element, distributed over the surface of the light guide. This design has the disadvantage that it has to be constructed very specifically for a specific part of a vehicle to be covered. Supplying the light guide domes shown there with light or energy for light sources also appears to be complex and space-consuming.

Against the background of the prior art, the present invention is based on the object of providing a lighting system which can be adapted to different trim elements with little effort and requires a low effort to set up. In addition, the smallest possible installation height is desirable.

The object is achieved with the features of the invention by a lighting system according to claim 1. In addition, the invention relates to a trim element having such a lighting system and to a vehicle door having a corresponding trim element and to a lighting surface module. The corresponding subclaims present useful implementations for the invention.

The invention thus relates to a lighting system for one or more trim elements for the passenger compartment of a means of passenger transport, in particular a motor vehicle, having a plurality of separate lighting surface modules which are arranged next to one another and each have at least one light injector and a support to or in which the lighting surface modules are fastened or can be fastened.

Due to the division into a plurality of surface lighting modules, the lighting system is universally adaptable to different shapes and forms of trim elements.

An advantageous embodiment of the lighting system can be that it has a lighting layer which, seen from the passenger compartment, is arranged above the lighting surface modules in such a way that it covers one or more of the lighting surface modules, and that light from one or more lighting surface modules is radiated through the lighting layer toward the passenger compartment.

Such a lighting layer can be understood to mean a light-guiding layer in which light can propagate parallel to the surface of the lighting layer with low attenuation. The light is partially coupled out from the lighting layer in the direction of the passenger compartment, so that the layer can appear to be evenly illuminated when viewed from the passenger compartment. Due to special decoupling elements, such as surface irregularities, roughnesses, or embedded particles, in certain places larger amounts of light can be coupled out, so that these regions appear brighter than the surroundings when seen from the passenger compartment. In this way, a desired light intensity distribution over the surface of the lighting layer can also be achieved.

Such a lighting layer can be designed to be completely transparent perpendicular to the layer, so that the light exiting the lighting surface modules can pass through the lighting layer with low attenuation and reach the passenger compartment. In many cases, the lighting layer has separate light sources for its illumination, although light can also be coupled into the lighting layer from the lighting surface modules using suitable measures. Thus, different lighting density distributions can also be realized by the combined use of the lighting surface modules with a lighting layer covering them. The regions corresponding to the surfaces of the lighting surface modules can then appear brighter for example than the lighting layer in the regions in which the exiting light is coupled out exclusively from the lighting layer.

As already indicated above, a further embodiment of the invention can provide that the lighting layer is assigned one or more light sources in the form of light-emitting diodes and/or light guides, which emit light into the lighting layer in such a way that the light propagates parallel to the surface of the lighting layer in the layer.

For example, light-emitting diodes can be arranged at the edges or flat sides of the lighting layer in order to radiate light from there into the layer. Light guides can also be guided parallel to the edges of the lighting layer in order to couple light radially out from the light conductors and into the lighting layer. Finally, light guides can also be integrated into the lighting layer, for example along its edge, in order to couple light out of the light conductors and into the lighting layer with particular efficiency. In this context, light guides can be understood to be strand-shaped bodies made of a transparent material, for example a transparent plastic, in particular polymethyl methacrylate, although if a separate light guide is integrated into the material of the lighting layer a certain difference in the refractive indices of the light guide and the lighting layer is required in order to maintain the light-conducting properties of the light guide.

A support of the lighting surface modules can in many cases be designed as a flat body made of a plastic. In one implementation, it can also be provided that the support has a plurality of recesses or openings, in particular in the form of half-shells, to receive lighting surface modules. The support can, for example, be designed as a substantially flat, plate-shaped body which can carry one or more lighting surface modules, wherein such a plate does not have to be flat but can also be curved in one or more directions. In such a plate-shaped support, recesses can be formed which, for example, can have a shape complementary to the outer shape/base surface shape of the lighting surface modules. The lighting surface modules can be held in recesses by clamping or by adhesive or tabs or can be fixed by other fastening means.

The support can also have, for example, continuous recesses into which the lighting surface modules are inserted. In this case, it is expedient to provide tabs or flanges or flange sections on the support or on the lighting surface modules in order to hold the lighting surface modules in openings in the support.

A further embodiment of the invention can provide, for example, that a plurality of lighting surface modules has the same geometric base surface shape or that the lighting system has two or more groups of lighting surface modules each having the same base surface shape.

Larger contiguous surfaces illuminated by the modules can be assembled from such identically shaped lighting surface modules as part of a trim element. Such similar lighting surface modules can be manufactured and processed easily and cost-effectively by standardizing the design.

If different groups of modules are provided, each of which has the same base surface shape, these shapes can be selected such that the lighting surface modules of different groups complement each other well to form overall surfaces, for example in the form of rectangular and square modules or in the form of circular and sickle-shaped modules, which can each be put together.

In a further embodiment, it can be provided that the lighting surface modules each have a base surface shape which, in at least one direction, in particular in a plurality of directions, allows for a gapless juxtaposition, in particular a square, triangular, hexagonal, rectangular, or sickle-shaped base surface shape, or that at least two groups of lighting surface modules are provided, the basic surface shapes of which complement one another in such a way that a combination of lighting surface modules from different groups can be juxtaposed in a gapless manner.

Such a design of the basic surface shapes of lighting surface modules allows many different shapes of contiguous surfaces to be produced, with which differently shaped trim elements can be illuminated in a gapless manner or with only small intermediate spaces up to the edges.

It can further be provided in one embodiment of the invention that the light injectors either have light-emitting diodes or each have a light guide terminal or a light guide end.

This means that the light that is to be coupled into the lighting surface modules can be generated directly at these modules in the light injectors by light-emitting diodes, or the light can be generated elsewhere at some distance from the light injectors, also by light-emitting diodes or light-emitting diode groups, in order to then be guided to the light injectors by light guides.

In any case, care should be taken that the light is well mixed, especially when it consists of a mixture of different wavelengths. This is easily done in a light guide over a certain length, but when using LEDs in the immediate vicinity of the light injectors, it is advantageous to use light mixing devices that mix the light from different light sources by reflection in such a way that a homogeneous color mixture is created. For this purpose, for example transparent plastic bodies are known, for example strand-shaped plastic body sections with a polygonal, for example hexagonal cross-section, which can be coated on the outside with a light or white and/or reflective coating and through which the light can be guided in order to achieve a mixture.

If a local LED light source with a light mixing device is used as the light source in the light injector, it is appropriate to provide an air gap between the light source and a light guide body of the lighting surface module to improve the mixing of the light.

In addition to a lighting system of the type described, the invention also relates to a trim element for the passenger compartment of a means of passenger transport with a lighting system of the type described, and also with a decorative layer that is, at least in sections, at least partially transparent or translucent, and is arranged above the lighting system, as seen from the passenger compartment.

The lighting system according to the invention can thus be used to backlight the surface of the trim element through the decorative layer. At least the translucent regions of the decorative layer can thus be illuminated while any non-translucent or transparent regions can remain dark.

It can also be advantageously provided that a masking layer is arranged below the surface of the decorative layer, which masking layer has sections that are opaque to light and sections that are transparent to light. This masking layer can assume the function of illuminating certain patterns on the surface of the trim element or of displaying, for example, symbols on the surface of the trim element through the specific shape of the transparent and opaque sections.

The invention can also relate to a trim element having a lighting layer into which light is coupled from at least one narrow side and having one or more lighting surface modules which are arranged on the side opposite the passenger compartment side of the lighting layer, and which are configured to emit light through the lighting layer toward the passenger compartment.

As already shown above, such a trim element can be designed particularly flexibly with respect to the light intensity distribution. The light intensity distribution is not statically defined, but can also be changed dynamically and depending on the situation.

In addition, the invention relates to a vehicle door having a trim element of the described type. By combining a trim element with a vehicle door, i.e., by installing the trim element in a vehicle door, specific functions can be realized in the vehicle door by means of the lighting system, which functions can be suitably coordinated with the functions of the vehicle door and any operating elements arranged in the vehicle door. For example, operating elements for window lifters can be integrated into the vehicle door and these can be highlighted by special backlighting.

The invention further relates to a lighting surface module, in particular for use in a lighting system of the type described or in a trim element of the type described, comprising a flat light distribution body having a base surface whose extension in each direction is greater than the thickness of the light distribution body and comprising a light injector which has a light source which is arranged such that it radiates light into the light distribution body perpendicular to the base surface of the light distribution body, and which is arranged on a flat side of the light distribution body that extends over the base surface.

Such a light distribution body can be designed to be flat and thereby overall have a substantially flat shape. Such lighting surface modules can thus be placed onto a flat or slightly curved lighting layer. The individual lighting surface modules can also have a slight screen shape in order to provide a shape suitable for coupling light in, which will be discussed in more detail further below. The possible base surface shapes of lighting surface modules have already been discussed in detail above. These shapes are intended to allow contiguous surfaces of trim elements to be covered in as gapless a fashion as possible, wherein the trim elements can have different shapes.

A special embodiment of lighting surface modules can provide that the light distribution body has a funnel-shaped bulge in the region in which a light injector is coupled thereto, into the tapering region of which the light injector radiates light, wherein a distance is provided in particular between the light source of the light injector and the material of the light distribution body.

Such a funnel-shaped bulge of the light distribution body can have a trunk shape in its tapering region, which forms a rod-shaped attachment made of the material of the light distribution body. Light can be radiated axially by a light source in this rod-shaped attachment. For this purpose, an LED module or a light-emitting diode can be placed on the rod-shaped attachment. For this case, it can be provided that mixing of light takes place within the rod-shaped attachment due to its design. For this purpose, the rod-shaped attachment can have a polygonal, in particular hexagonal, outer contour in cross-section. If the light source is in the end of the light guide which is placed onto the rod-shaped attachment and, for example, glued thereto, then light mixing is not necessary at this point, since any inhomogeneous light composed of different light colors is reliably mixed in the course of a light guide.

Such a light guide can, for example, be routed from the edge of the trim element, for example also from the edge of a lighting layer where light-emitting diode modules can be arranged to generate the light, to the individual light injectors.

The extension of a light distribution body with a screen shape perpendicular to its base surface is in many cases less than 20%, in particular less than 10% of its largest extension parallel to the base surface. The material thickness of the material of the light guide body can continuously decrease from its center toward the edges in the radial direction. The thickness of the material of the light distribution body can, for example in the center, be less than 5% or less than 2% of the largest extension of the light guide body parallel to its base surface.

It can additionally be provided according to the invention that a half-shell-shaped housing or a support is arranged on the side of the light distribution body opposite the passenger compartment side, which housing or support is metallically reflective or coated with a reflective color, in particular a white color, on its side facing the light distribution body.

In this case, for example, each lighting surface module can have its own half-shell-shaped housing which partially encloses the module on its side facing away from the passenger compartment. The housing is then expediently designed in terms of its surface design in such a way that it reflects as large a proportion as possible of the light exiting from the light distribution body on this side back into said light distribution body.

Different housings of adjacent lighting surface modules can also be combined in one support, wherein the support as a whole can substantially form the shape of a plate with recesses, wherein the recesses then each form half-shell-shaped receptacles for the lighting surface modules.

In a further embodiment, it can be provided that the light distribution body has on its side opposite the light injector, in the region in which the light is radiated in, a partially reflective layer whose reflection coefficient is in particular greater than 50%, further in particular greater than 60%, wherein the partially reflective layer is partially permeable to light or has openings which allow light to pass through.

Since the light is radiated from the light source perpendicular to the base surface of the corresponding lighting surface module and thus also perpendicular to the base surface of the light distribution body, a large portion of the light impinges on the opposite side of the light distribution body on its boundary surface close to the perpendicular direction, and can exit the light distribution body toward the passenger compartment side. As a result, most of the coupled light is emitted in the region of the lighting surface module opposite the light injector. As seen from the passenger compartment, this would lead to the formation of very bright spots, known as hot spots. In order to prevent this inhomogeneity in the light distribution, it is provided that the majority of this light is reflected back into the light distribution body by a partially reflective layer, so that it can exit from the light distribution body at another point, in a better distributed manner. In order not to generate a completely dark spot in the mentioned region, the partially reflective layer is designed such that it allows a portion of the light to pass through, so that overall a uniform distribution of the exiting light on the passenger compartment side is achieved over the base surface of the lighting module.

In a further embodiment of the invention, it can be provided that the partially reflective layer is applied to the light distribution body as a surface coating in the form of a reflective color or a metallization, in particular by means of a PVD (physical vapor deposition) method, or is integrated into the light distribution body by means of a production in sections of the light distribution body from a multi-component mixture.

The partially reflective layer can be achieved by metallizing the light distribution body in this region, optionally with passage openings, or also by adding a further material component to the material of the light distribution body in the mentioned region, which further material component causes scattering and/or reflection in this region.

It can also be provided, for example, that the light distribution body has a plurality of uneven areas of its surface on its side opposite the passenger compartment side, in particular raised parts and/or recesses and/or or a roughening of the surface and/or a reflective surface coating, which effect a scattering of the light toward the passenger compartment side of the light distribution body.

The aforementioned inhomogeneities or irregularities on the light distribution body are also called extraction elements, as they lead to the deflection/scattering of light inside the light distribution body, which can then be radiated perpendicular to the base surface of the light distribution body. A uniform emission of light on the passenger compartment side of the light distribution body can be achieved by a uniform distribution of the uneven areas/inhomogeneities on the surface of the light distribution element. For example, the uneven areas can have the shape of cylindrical recesses or raised parts which are distributed on concentric circles on the outer surface of the light distribution body, which concentrically surround the location of the light injector.

It can also be provided that the light distribution body is made of polycarbonate or polymethyl methacrylate.

The mentioned materials provide stiffness to the lighting surface module and of the light distribution body, so that this body is given sufficient inherent stability. In addition, the materials are transparent in such a way that they do not cause any color filtering or color influencing of the emitted light.

In a further embodiment of a lighting surface module, it can also be provided that the light source is formed by an LED module or a light guide end, wherein the light distribution body has a light mixing device in particular in the region in which a light injector having an LED module is coupled to the LED module.

As already mentioned above, a light mixing device can consist of a transparent material section which for example has a polygonal cross-section and can be coated on its outer side in a reflective or partially reflective manner.

To power the light injectors of the lighting surface modules, depending on the design of the light sources, power supply lines or light conductors are attached to the support, which are connected to the light injectors. The power supply lines can be pre-assembled in the form of a cable harness to facilitate installation, and spacers or positioning elements can be provided between the individual power supply lines to adapt the positioning to the geometric distribution of the light injectors and to keep the installation effort low.

In the following, the invention is illustrated on the basis of exemplary embodiments in figures of a drawing and explained below.

In the drawings:

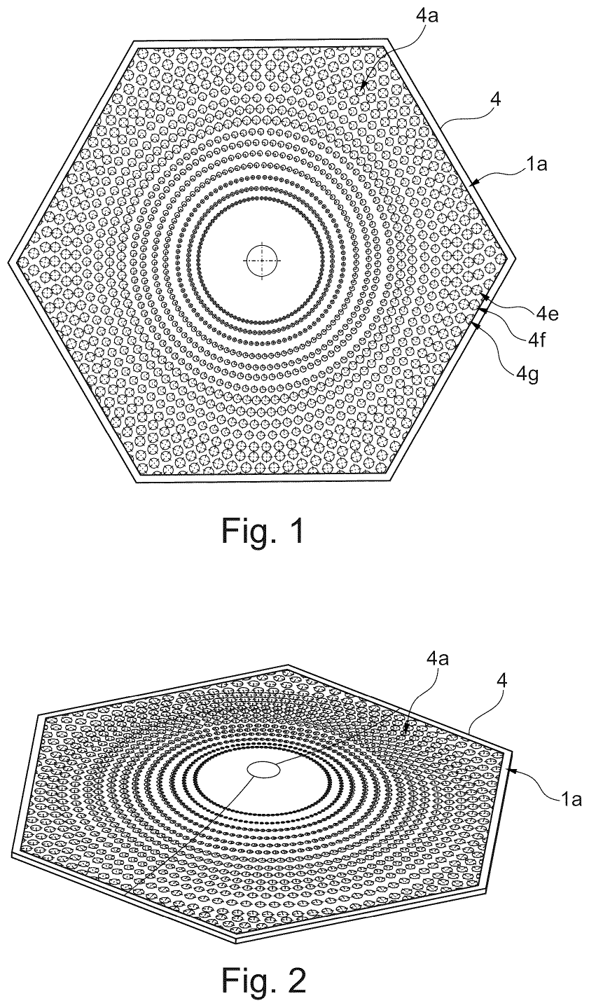

FIG. 1 shows parts of a hexagonal lighting surface module in a plan view,

FIG. 2 shows parts of the lighting surface module from FIG. 1 in a perspective view,

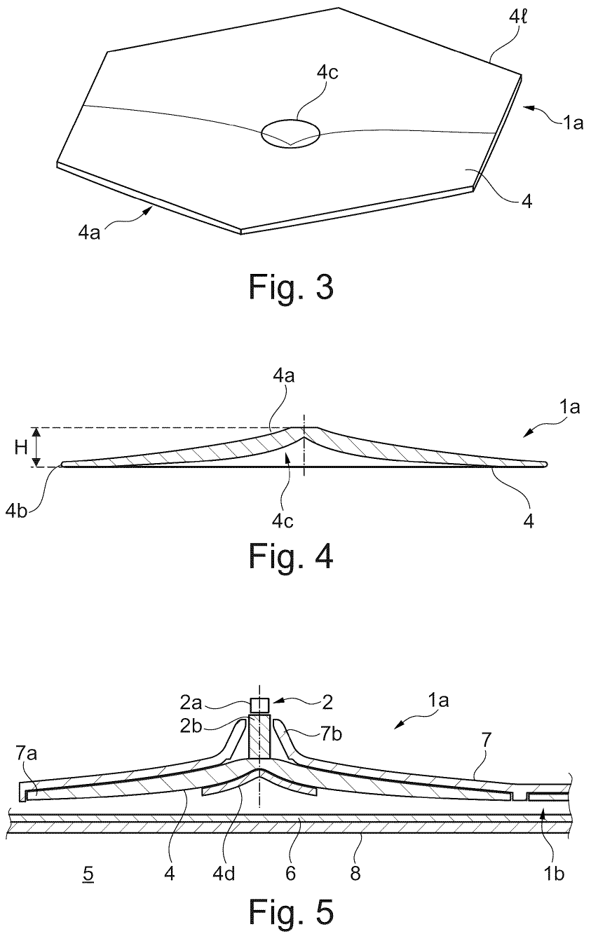

FIG. 3 shows a light guide body of a lighting surface module viewed from the passenger compartment side,

FIG. 4 shows a light guide body in a cross-section,

FIG. 5 shows a light guide body having a part of a support, a lighting layer and a decorative layer, in a cross-section,

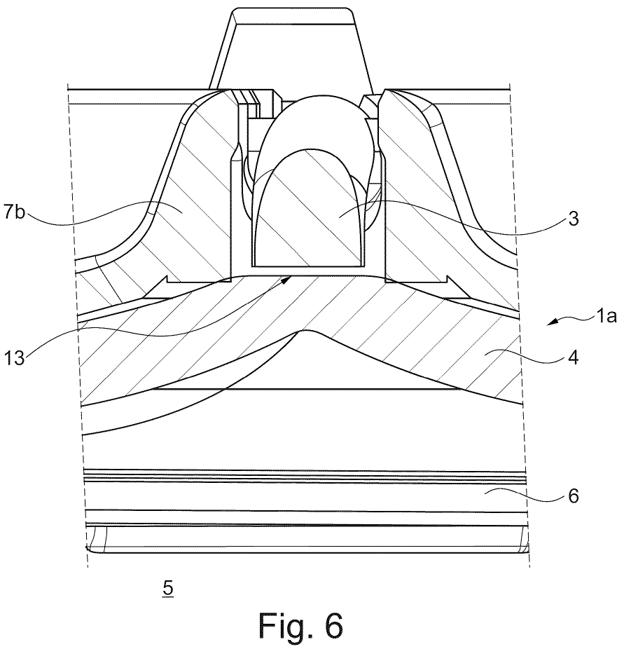

FIG. 6 shows a detail of parts of a lighting surface module in cross-section,

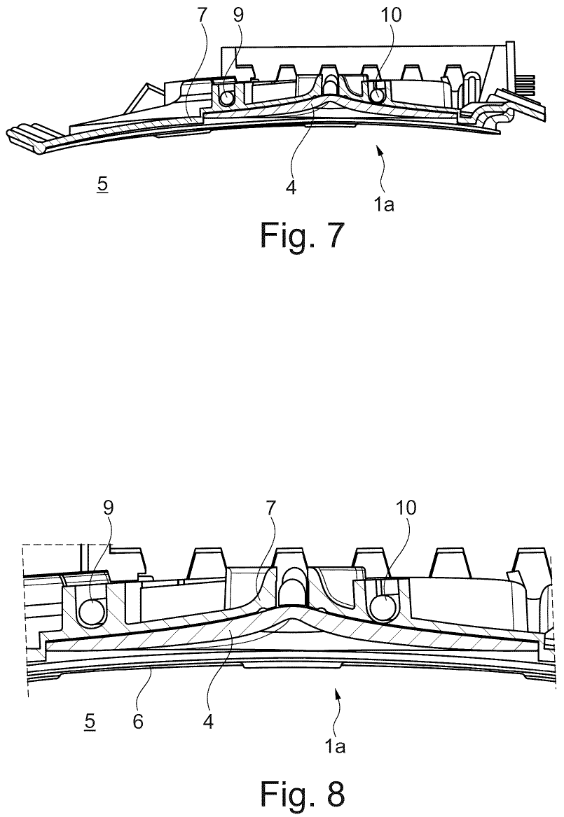

FIG. 7 shows a lighting surface module with parts of a support in cross-section,

FIG. 8 shows parts of FIG. 7 at an enlarged scale,

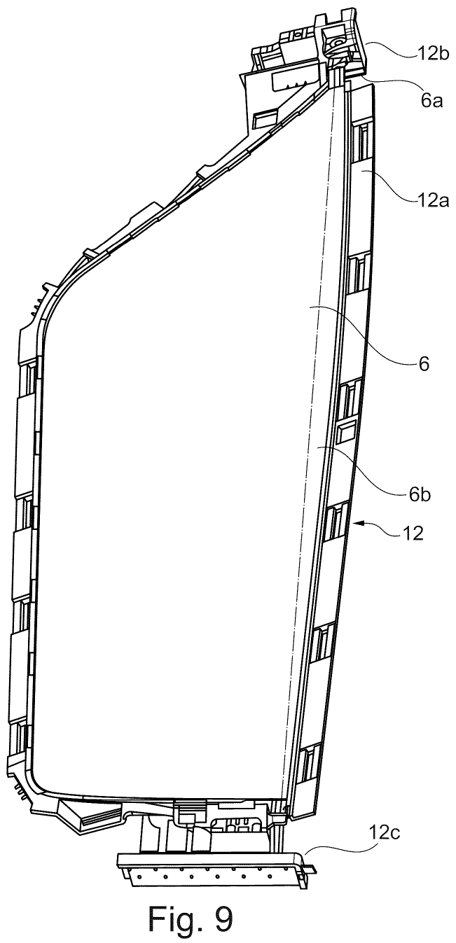

FIG. 9 shows a lighting layer of a trim part with a light source for lighting surface modules in the form of an LED module,

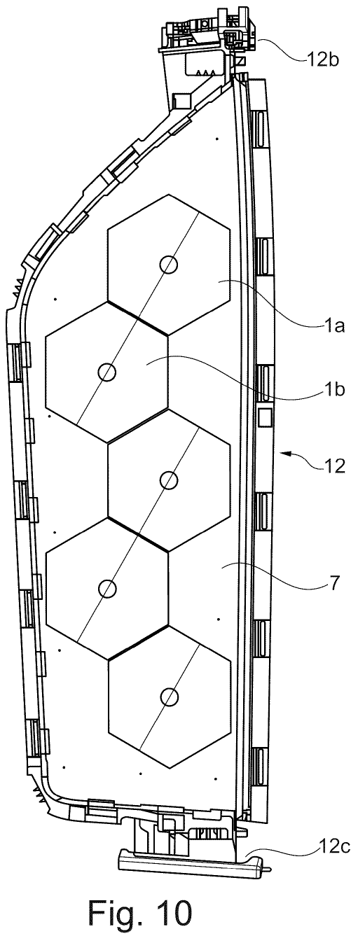

FIG. 10 shows parts of a trim element with a support having lighting surface modules,

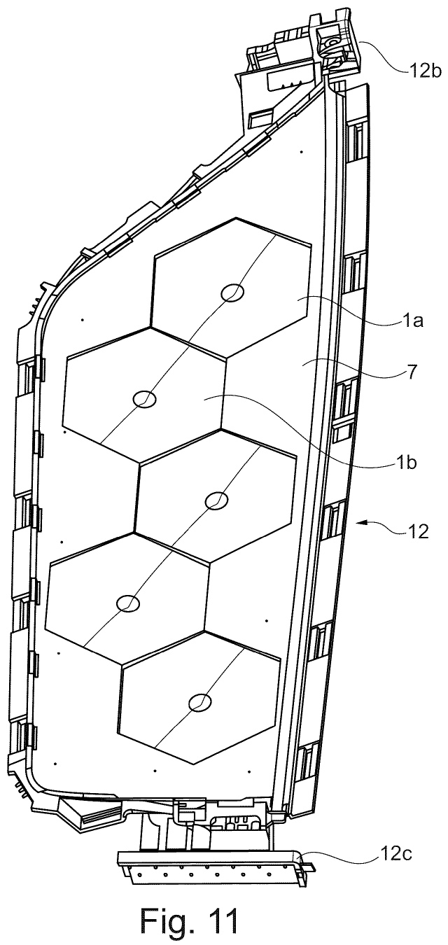

FIG. 11 shows parts of a trim element as in FIG. 10, but in a perspective representation, rotated relative to FIG. 10,

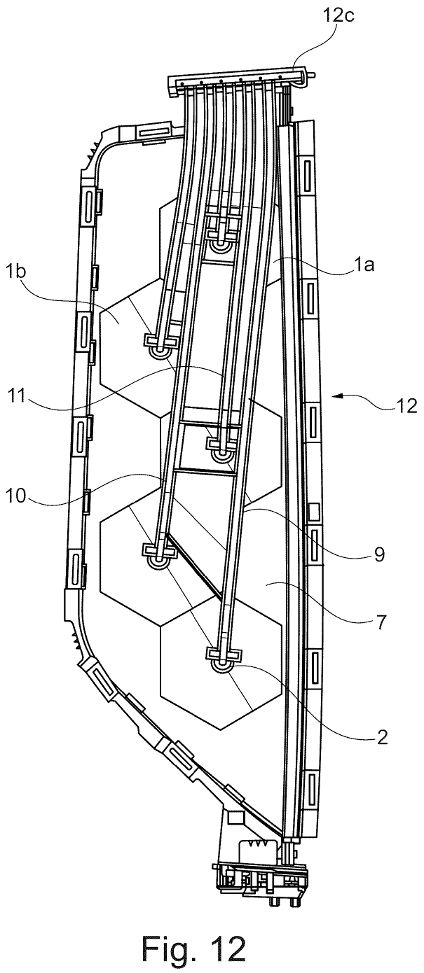

FIG. 12 shows a view of the trim element from FIGS. 10 and 11, additionally with distribution lines for light,

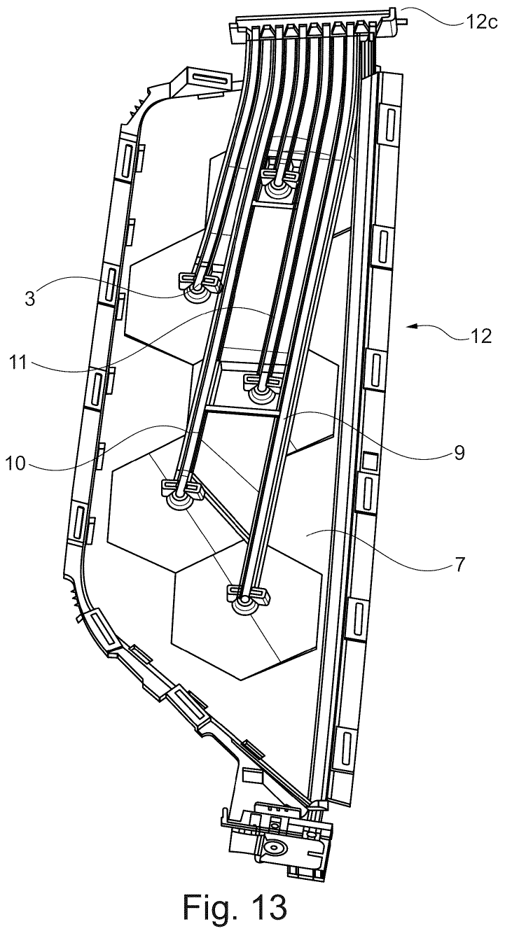

FIG. 13 shows a trim element as shown in FIG. 12 in a perspective representation, rotated relative to the representation of FIG. 12,

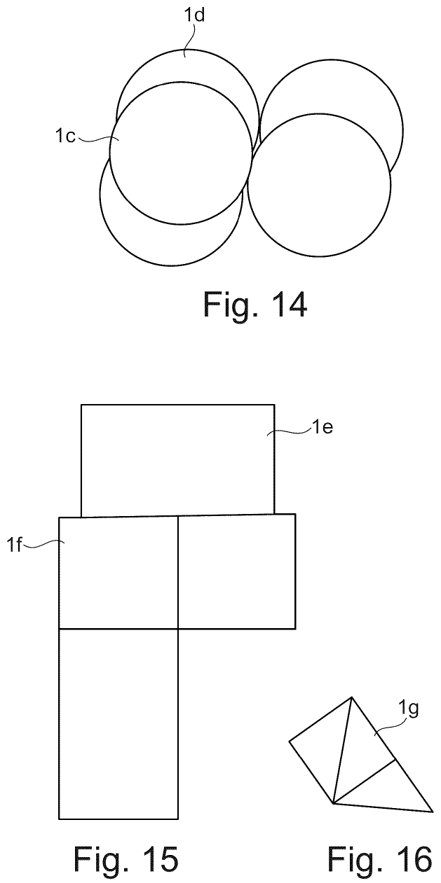

FIG. 14 shows a plurality of lighting surface modules combined to form an overall surface, in the form of circular disks and circular sickles,

FIG. 15 shows a plurality of lighting surface modules combined to form an overall surface, in the form of squares and rectangles,

FIG. 16 shows a plurality of lighting surface modules combined to form an overall surface, in the form of triangles.

FIG. 1 shows, in a plan view, a light distribution body 4 from its flat side 4a as part of a lighting surface module 1. The light distribution body has a hexagonal shape and is shown from side 4a, which is opposite the passenger compartment side when used as intended in a trim element. On this side 4a, the light distribution body 4 bears cylindrical raised parts 4e, 4f, 4g, which are distributed in rows in a circular ring around the center of the light distribution body. Instead of the raised parts, cylindrical recesses can also be provided. The diameter of the raised parts and recesses can be variable in such a way as to increase with increasing distance from the center of the light distribution body. Of course, a different shape of raised parts or recesses can also be provided and/or the surface of the light distribution body can be roughened or reflectively coated.

FIG. 2 shows the light distribution body from FIG. 1 in a perspective view.

FIG. 3 shows a light distribution body 4 of a lighting surface module 1a from the side opposite to the side 4a and accordingly facing the passenger compartment side when used as intended. In the center of the light distribution body 4 the bulge 4c is shown, which is intended to allow light to be coupled in from the flat side 4a. On the side of the light distribution body 4 shown, it is designed with a flat, smooth surface.

FIG. 4 shows a cross-sectional view of the light distribution body 4 from FIG. 3, wherein the bulge 4c can be seen. For clarity, the raised parts/recesses on the flat side 4a are not shown.

It can be seen that the material thickness of the light distribution body is significantly less than the largest extension of the base surface of the light distribution body and even in the thickest region is less than 10% or less than 5% of the largest extension of the base surface. The extension H of the light distribution body in the direction perpendicular to the base surface can be less than 20% or even less than 10% of the largest extension of the base surface.

FIG. 4 also shows that the material thickness of the light distribution body 4 decreases from the center towards the edge/circumferential side 4b.

FIG. 5 shows a cross-section of a light distribution body 4 which is arranged in a recess 7a of a support 7. The support 7 has a plurality of such recesses 7a next to one another for receiving a plurality of light distribution bodies 4 from different lighting surface modules 1a, and can consist for example of a metal sheet or of a plastics material. The sides of the recesses 7a of the support facing the light distribution bodies 4 can be metallized or reflective, for example brightly coated, in order to amplify the reflection.

A lighting layer 6 is shown in front of the lighting surface modules 1a in the direction of the passenger compartment 5 and a decorative layer 8 is shown in front of this, closest to the passenger compartment 5.

The support 7 has a recess in the center of each recess 7a for a light distribution body 4, which recess is surrounded by a collar 7b and through which a light injector 2, 3 can at least partially protrude.

FIG. 5 shows a strand-shaped light guide 2b which is placed on the light distribution body 4 with an air gap in between and is used as a light mixing device. In the exemplary embodiment shown in FIG. 5, light of different wavelengths is irradiated into the light mixing device 2b by a light source 2a in the form of a light-emitting diode arrangement, which light is mixed and homogenized in the light mixing device. For this purpose, a reflective, bright/white or metallic coating can be provided on the circumferential side of the light guide 2b. In addition, the light guide 2b can be polygonal in cross-section, for example hexagonal. The strand-shaped light guide 2b can also be integrally connected to the light distribution body, can be made of the same material as this body, and can be produced together with it in a manufacturing process, for example by injection molding. This ensures particularly efficient light transfer to the other parts of the light distribution body.

Irrespective of the type of coupling in of light through a light injector into the light distribution body 4, a reflective coating 4d, preferably in a circular shape, can be provided in a central region of the light distribution body, directly surrounding the center, on the flat side facing the passenger compartment. The coating can be designed to be partially reflective and partially permeable to light in order to prevent the strong light intensity from the opposite side of the light distribution body from directly passing through there completely, which would result in a bright spot and inhomogeneous light distribution on the passenger compartment side. The light is reflected back into the light distribution body by the coating and is further distributed homogeneously there.

In order not to completely darken the coated region, the coating is designed to be partially permeable.

The coating can be designed as a metallization, for example with passage openings for a certain residual amount of light, or as a bright, reflective color coating. The coating can for example be applied to the light distribution body by means of a PVD (physical vapor deposition) method. The partially reflective layer 4d can also be achieved within the material of the light distribution body by a 2-component design in its surface region, for example by embedding scattering particles there.

FIG. 6 shows a detail from a cross-sectional view of a lighting surface module 1a with a light distribution body 4, a collar 7b of a support, a lighting layer 6 in front of the lighting surface module, and with a portion of a light injector in the form of a light guide end 3 which is surrounded by the collar 7b of the support and ends at a distance 13 before the central region of the light distribution body, which is provided as a coupling-in point for the light. The end 3 of the light guide, which is routed from the light-generating LED module at the edge of the trim element for the most part substantially parallel to the support 7 of the lighting surface modules, is bent by 90 degrees perpendicular to the light distribution body in the region of the light injector and ends vertically in front of it with a gap in order to allow compensation for length tolerances and to avoid frictional contact between the end of the light guide end and the material of the light distribution body. The distance is denoted in FIG. 6 by the reference sign 13 and can be from 1 to several millimeters, for example. A bent part of a light guide is shown above the light coupling point.

FIG. 7 shows a larger detail of a cross-sectional view similar to that in FIG. 6, in which larger parts of the support 7 can also be seen on the side of the lighting surface module 1a facing away from the passenger compartment 5. In addition, the distribution lines 9, 10 are also shown on the support 7 in cross-section, which distribution lines are designed as light guides but could also be designed as electrical distribution lines for supplying power to LED modules arranged on the light injectors.

FIG. 8 shows an enlarged detail from the cross-sectional view of FIG. 7. As in FIG. 7, the lighting layer 6 is shown in front of the lighting surface module la in the direction of the passenger compartment 5.

In FIG. 9, parts of a trim element 12 are shown with a frame 12a, but still before the installation of lighting surface modules. The lighting layer 6 can be seen, as well as a frame 12a of the trim element. In addition, a light-emitting diode (LED) module 12b is shown, from which light is introduced into the lighting layer via a light guide 6a which is largely integrated into the lighting layer 6.

The light guide 6a runs in the material of the lighting layer 6 at its edge, approximately along the dashed line 6b. From there, light is coupled out radially into the lighting layer so that this lighting layer is evenly illuminated.

On the side opposite the LED module 12b, a further LED module 12c is arranged at the edge of the lighting layer 6 and the trim element 12, which further LED module is provided to supply a plurality of light injectors of the lighting surface modules with light via light guides.

FIG. 10 shows the trim element 12 after the installation of a support 7 for lighting surface elements 1a, 1b with hexagonal base surfaces. The lighting surface elements 1a, 1b each lie with two of their straight boundary edges adjacent to the boundary edges of neighboring lighting surface modules and are therefore juxtaposed without gaps. They fill the majority of the surface of the trim element 12. A wide variety of forms of contiguous or interrupted lighted surfaces can be formed by a plurality of lighting surface modules arranged next to one another. The lighting system can be designed to be self-supporting by attaching the lighting surface modules to a support, so that, given a covering which may be provided by a decorative layer toward the passenger compartment, there is a high degree of flexibility with regard to the design and choice of materials for a decorative layer or plurality of layers covering the lighting system toward the passenger compartment.

By dividing the surface to be backlit into a plurality of lighting surface modules, these can be combined dynamically depending on the requirements of a trim element. Desired lighting patterns can also be realized by individually controlling the lighting of each lighting surface module, and these can also be controlled in a time-dependent manner, so that moving lighting patterns can also be realized. The replacement or repair of defective modules is also easily possible and is less expensive than the replacement of an entire lighting system.

FIG. 11 shows the trim element from FIG. 10 in a perspective position which is slightly rotated relative to FIG. 10. In this position, additional details of the LED module 12b for supplying light to the light injectors and of the LED module 12c for illuminating the lighting layer can be seen.

FIG. 12 shows the trim element 12 with the support 7 and the lighting surface modules, wherein the distribution lines 9, 10, 11 for the light are also installed, which lead from the LED module 12c to the light injectors 2. In accordance with the number of five lighting surface modules shown, five light guides are also shown as distribution lines. FIG. 13 shows the same assembly state as FIG. 12 from a somewhat rotated perspective in order to make additional details visible. It should be noted that FIGS. 12 and 13 are rotated by 180 degrees in the plane of the drawing compared to FIGS. 10 and 11.

FIG. 14 shows by way of example the base surfaces of lighting surface modules 1c and 1d in a combination with a plurality of circular disk-shaped base surfaces 1c and a plurality of sickle-shaped base surfaces 1d which are joined together at least partially without gaps to form closed overall surfaces. Two groups of lighting surface modules are thus combined there, each having the same base areas.

FIG. 15 shows a similar constellation, in which a group of lighting surface modules with a square base shape 1f is combined with lighting surface modules 1e of a second group of modules, each of which has the same rectangular shape.

FIG. 16 shows a combination of lighting surface modules 1g, each with a triangular base shape, which are assembled without gaps.

The described embodiments thus allow a flexible design of the backlighting of a trim element, for example for a door of a vehicle, which allows an efficient and cost-effective series production of lighting surface modules and simple and space-saving installation.

1. Lighting system for one or more trim elements (12) for a passenger compartment (5) of a means of passenger transport, in particular a motor vehicle, comprising a plurality of separate lighting surface modules (1a, 1b, 1c, 1d, 1e, 1f, 1g, 2, 3, 4) which are arranged next to one another and each comprise at least one light injector (2, 3), and a support (7) to or in which the lighting surface modules are fastened or can be fastened.

2. The lighting system according to claim 1, characterized by a lighting layer (6) which is arranged above the lighting surface modules (1a, 1b, 1c, 1d, 1e, 1f, 1g, 2, 3, 4) as viewed from the passenger compartment (5), such that the lighting layer (6) covers one or more of the lighting surface modules (1a, 1b, 1c, 1d, 1e, 1f, 1g, 2, 3, 4), and that light from one or more lighting surface modules (1a, 1b, 1c, 1d, 1e, 1f, 1g, 2, 3, 4) is radiated through the lighting layer (6) towards the passenger compartment.

3. The lighting system according to claim 1, characterized in that the support (7) comprises a plurality of in particular half-shell-shaped recesses (7a) or openings for receiving the lighting surface modules (1a, 1b, 1c, 1d, 1e, 1f, 1g, 2, 3, 4).

4. The lighting system according to claim 1, characterized in that the support (7) comprises or supports a plurality of distribution lines (9, 10, 11) for distributing electrical energy or light to a plurality of light injectors (2, 3) of the lighting surface modules (1a, 1b, 1c, 1d, 1e, 1f, 1g, 2, 3, 4).

5. The lighting system according to claim 1, characterized in that a plurality of lighting surface modules (1a, 1b, 1c, 1d, 1e, 1f, 1g, 2, 3, 4) has the same geometric base surface shape or that the lighting system has two or more groups of lighting surface modules each having the same base surface shape, wherein it is provided in particular that the lighting surface modules in each case have a base surface shape which allows a gapless juxtaposition in at least one direction, in particular in a plurality of directions, in particular a square, triangular, hexagonal, rectangular, or sickle-shaped base surface shape, or that at least two groups of lighting surface modules are provided, the base surface shapes of which complement one another in such a way that a combination of lighting surface modules from different groups can be juxtaposed without gaps.

6. A trim element (12) for a passenger compartment of a means of passenger transport with a lighting system according to claim 1 and with a decorative layer (8) that is, at least in sections, at least partially transparent or translucent and is arranged above the lighting system as seen from the passenger compartment (5).

7. A vehicle door comprising a trim element according to claim 6.

8. A lighting surface module (1a, 1b, 1c, 1d, 1e, 1f, 1g, 2, 3, 4), comprising a flat light distribution body (4) having a base surface whose extension in each direction is greater than the thickness of the light distribution body and comprising a light injector (2, 3) which has a light source (2a, 2b) which is arranged such that it radiates light into the light distribution body perpendicular to the base surface of the light distribution body, and which is arranged on a flat side (4a) of the light distribution body that extends over the base surface.

9. The lighting surface module (1a, 1b, 1c, 1d, 1e, 1f, 1g, 2, 3, 4) according to claim 8, characterized in that the light distribution body (4) has a base surface shape which allows a gapless juxtaposition of a plurality of identically shaped lighting surface modules in at least one direction, in particular in a plurality of directions, in particular the base surface shape of a triangle, a rectangle, trapezoid, parallelogram, or square, a hexagonal shape, or a sickle shape.

10. The lighting surface module (1a, 1b, 1c, 1d, 1e, 1f, 1g, 2, 3, 4) according to claim 8, characterized in that the light distribution body (4) has a funnel-shaped bulge (4c) in the region in which a light injector (2, 3) is coupled thereto, into the tapering region of which the light injector (2, 3) radiates light, wherein in particular a distance (13) is provided between the light source of the light injector and the material of the light distribution body.

11. The Lighting surface module (1a, 1b, 1c, 1d, 1e, 1f, 1g, 2, 3, 4) according to claim 8, characterized in that a half-shell-shaped housing or a support (7) is arranged on the side of the light distribution body (4) opposite the passenger compartment side (5), which housing or support is metallically reflective or coated with a reflective color, in particular a white color, on its side facing the light distribution body.

12. Lighting surface module (1a, 1b, 1c, 1d, 1e, 1f, 1g, 2, 3, 4) according to claim 8, characterized in that the light distribution body (4) has on its side opposite the light injector (2, 3) in the region in which the light is radiated in, a partially reflective layer (4d) whose reflection coefficient is in particular greater than 50%, further in particular greater than 60%, wherein the partially reflective layer is partially permeable to light or has openings which allow light to pass through.

13. Lighting surface module (1a, 1b, 1c, 1d, 1e, 1f, 1g, 2, 3, 4) according to claim 12, characterized in that the partially reflective layer (4d) is applied as a surface coating in the form of a reflective color or a metallization onto the light distribution body (4), in particular by means of a PVD method, or is integrated into the light distribution body by means of a production in sections of the light distribution body from a multi-component mixture.

14. Lighting surface module (1a, 1b, 1c, 1d, 1e, 1f, 1g, 2, 3, 4) according to claim 8, characterized in that the light distribution body (4) has, on its side opposite the passenger compartment side (5), a plurality of uneven areas (4e, 4f, 4g) of the surface, in particular raised parts and/or recesses and/or or a roughening of the surface and/or a reflective surface coating, which effect a scattering of the light toward the passenger compartment side (5) of the light distribution body.

15. Lighting surface module (1a, 1b, 1c, 1d, 1e, 1f, 1g, 2, 3, 4) according to claim 8, characterized in that the light source (2a, 3) is formed by an LED module or a light guide end, wherein the light distribution body (4) has a light mixing device (2b) in particular in the region in which a light injector having an LED module is coupled to the LED module.
